(19) United States
(12) Patent Application Publication
(10) Pub. No.: US 2011/0062678 A1
(43) Pub. Date: Mar. 17, 2011

(54) CHAINLESS BICYCLE DRIVE SYSTEM WITH SPEED CHANGE ARRANGEMENT

(76) Inventors: Yuan-Hai Chen, Miaoli County (TW); Cheng-Hsiung Chen, Miaoli County (TW)

(21) Appl. No.: 12/585,368

(22) Filed: Sep. 14, 2009

(51) Int. Cl. B62M 1/02

(52) U.S. Cl. 280/260

(57) ABSTRACT

A chainless bicycle includes a drive system having a speed change arrangement is provided. In a first mode of speed change a forward pulling of a forward cable clockwise pivots a front pivotal member to move the forward sleeve rearward so that a first toothed portion of the forward sleeve clears a second gearwheel to move into a first gearwheel to mesh with a toothed portion of the first gearwheel whereby rotating a shaft will rotate a drive gear, the first gearwheel, the second gearwheel, the forward sleeve, a drive shaft, a rear sleeve, a fourth gearwheel, second inner engaging members, second outer engaging members, a third gearwheel, and a rear axle co-rotating with a rear wheel.

### BACKGROUND OF THE INVENTION

1. Field of Invention

The invention relates to chainless bicycles and more particularly to a chainless bicycle drive system having a speed change arrangement.

2. Description of Related Art

Chainless (i.e., shaft-driven) bicycles are well known in the art. Chainless bicycles have the advantages of presenting no danger of clothing or fingers being drawn into the chain and sprockets, less maintenance cost, etc.

A conventional chainless bicycle is shown in FIG. 1. In driving a bicycle a shaft 1 is rotated by pedaling. And in turn, a first bevel gear 2 rotates. A second bevel gear 6 meshed with the first bevel gear 2 rotates same. A drive shaft 5 has one end mounted with the second bevel gear 6 and the other end mounted with a third bevel gear 7. Hence, both the drive shaft 5 and the third bevel gear 7 rotate. A fourth bevel gear 4 meshed with the third bevel gear 7 rotates same. Finally, a rear axle 3 coaxially mounted with the third bevel gear 7 rotates.

One drawback of the conventional chainless bicycle is that only single speed can be effected. That is, it is not a labor saving bicycle. Thus, the need for improvement still exists.

### SUMMARY OF THE INVENTION

It is therefore one object of the invention to provide a chainless bicycle drive system having a speed change arrangement

The above and other objects, features and advantages of the invention will become apparent from the following detailed description taken with the accompanying drawings.

### BRIEF DESCRIPTION OF THE DRAWINGS

FIG. 1 is a cross-sectional view of drive system of a conventional chainless bicycle;

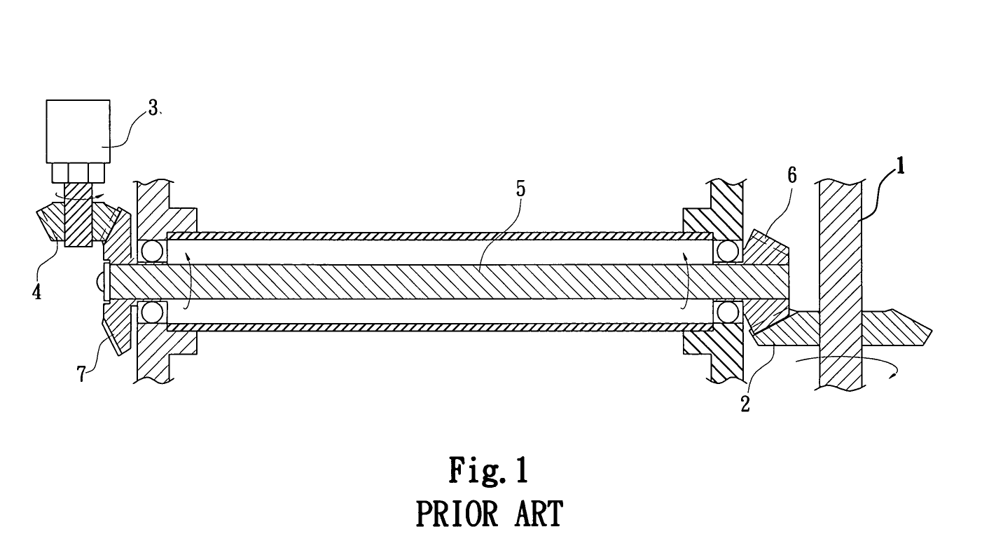

FIG. 2 is an exploded view of a first preferred embodiment of drive system of a chainless bicycle according to the invention;

FIG. 3 is a perspective view of the assembled drive system of FIG. 2;

FIG. 4 is a cross-sectional view of the drive system of FIG. 3;

FIG. 5 shows details of the areas in circles A and B of FIG. 4;

FIG. 6 is a view similar to FIG. 4 showing a pedaling operation of the bicycle;

FIG. 7 is a side elevation of the drive system of FIG. 3 showing a speed change operation of the bicycle by pulling the forward cable forward;

FIG. 8 is a cross-sectional view of the drive system of FIG. 7 also showing the speed change operation of the bicycle;

FIG. 9 shows details of the areas in circles C and D of FIG. 8;

FIG. 10 is a side elevation of the drive system of FIG. 3 showing a speed change operation of the bicycle by pulling the rear cable rearward;

FIG. 11 is a cross-sectional view of the drive system of FIG. 10 also showing the speed change operation of the bicycle;

FIG. 12 shows details of the areas in circles E and F of FIG. 11;

FIG. 13 is an exploded view of a second preferred embodiment of drive system of a chainless bicycle according to the invention;

FIG. 14 is a cross-sectional view of the drive system of FIG. 13; and

FIG. 15 shows details of the areas in circles G and H of FIG. 14.

### DETAILED DESCRIPTION OF THE INVENTION

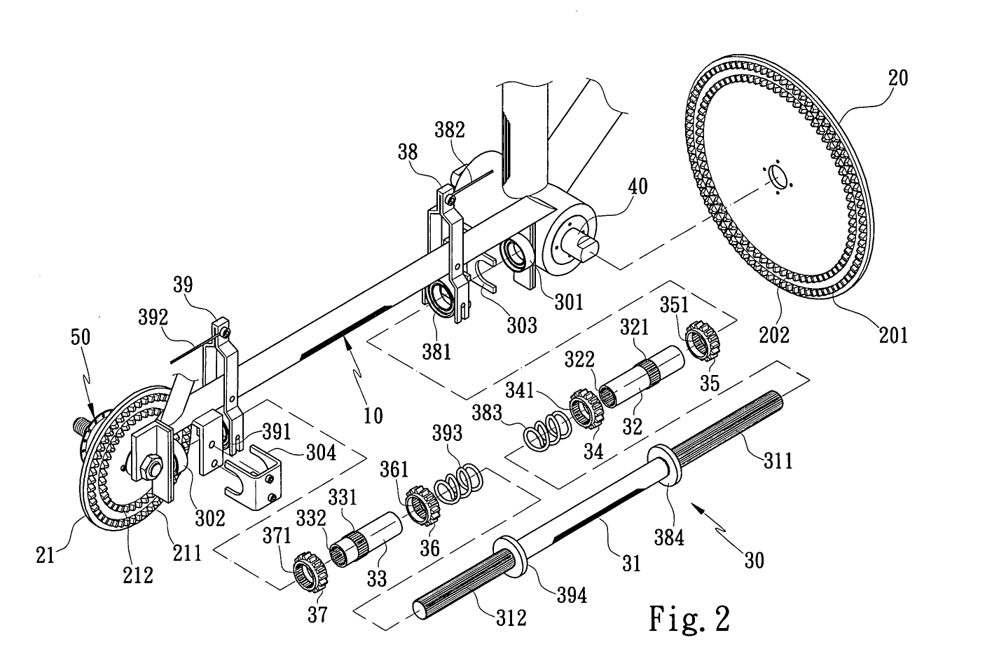

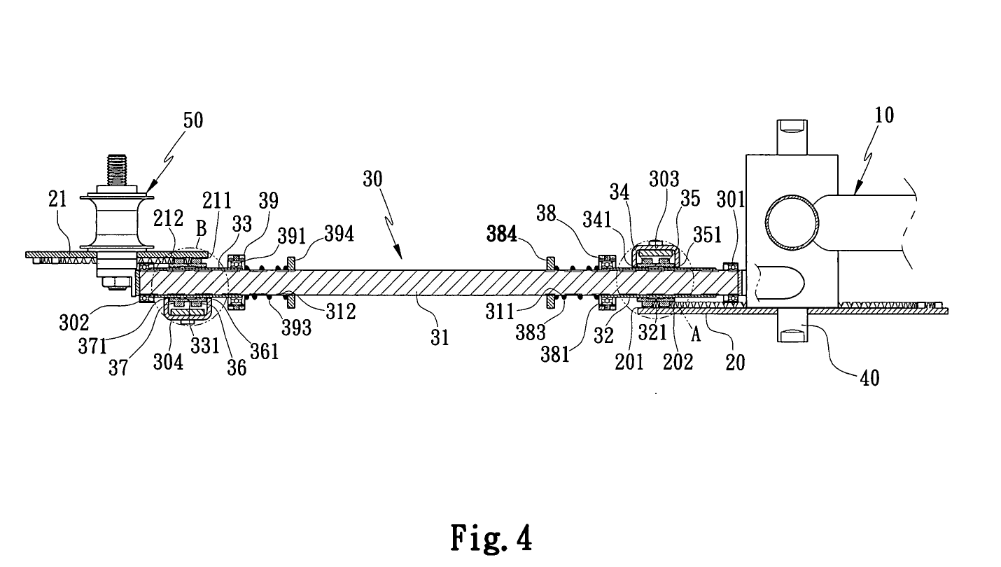

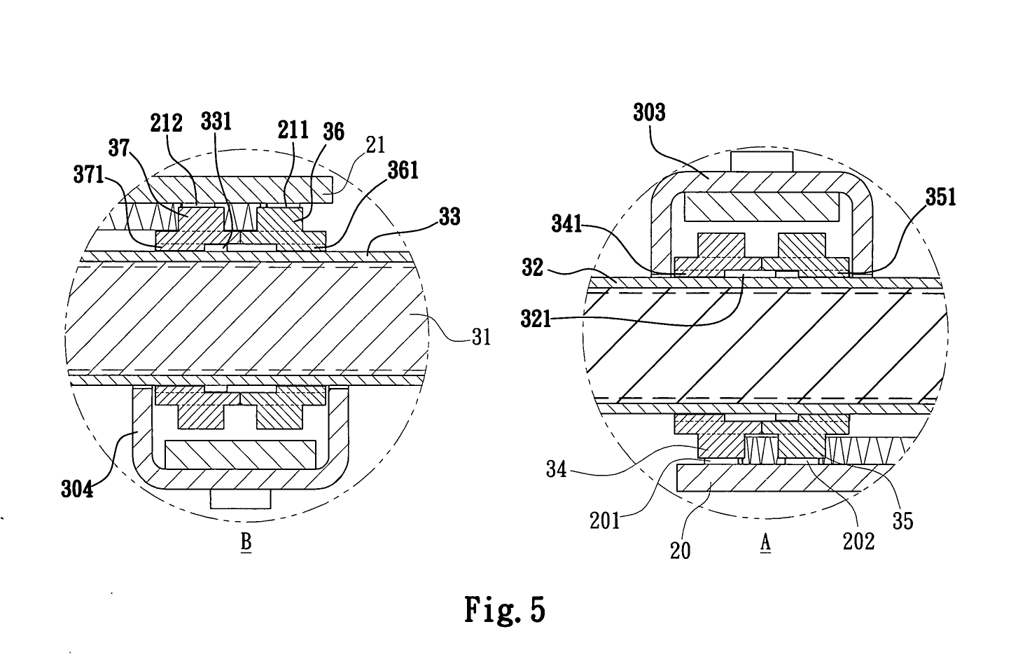

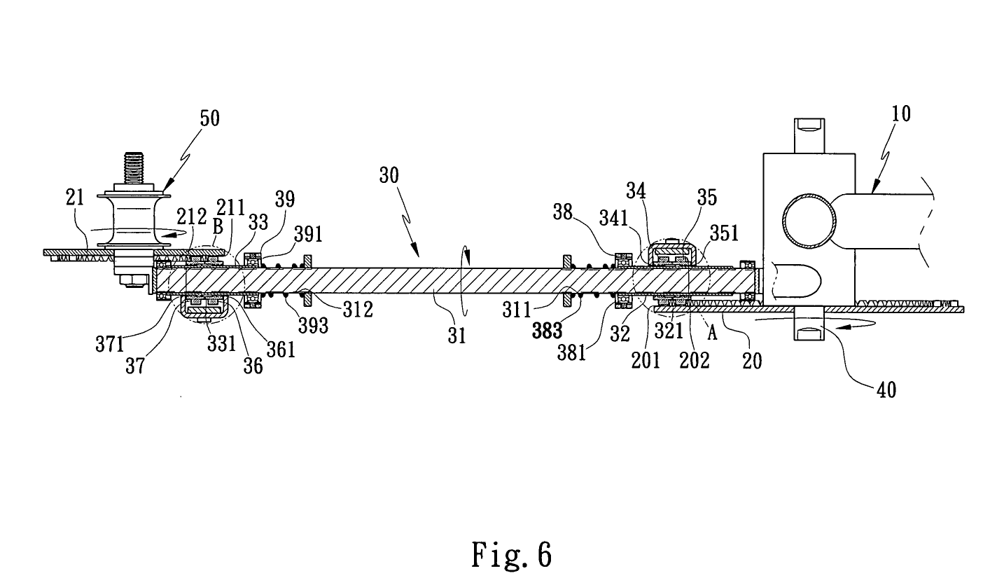

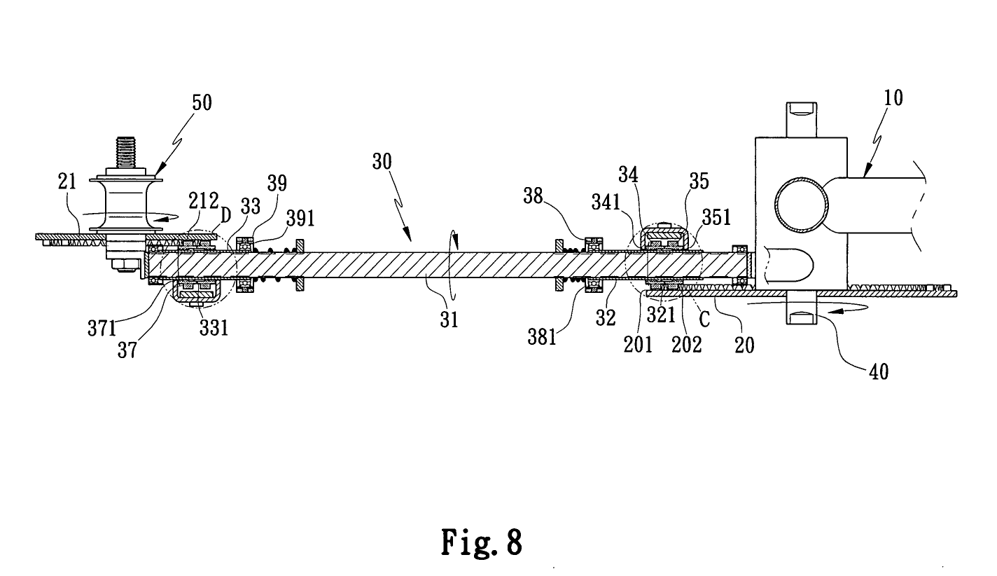

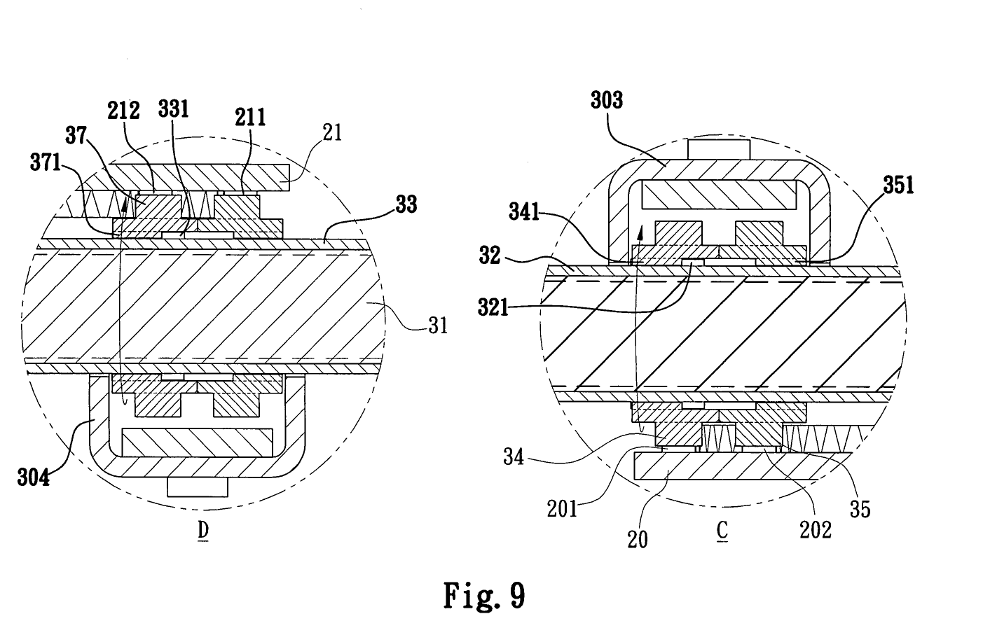

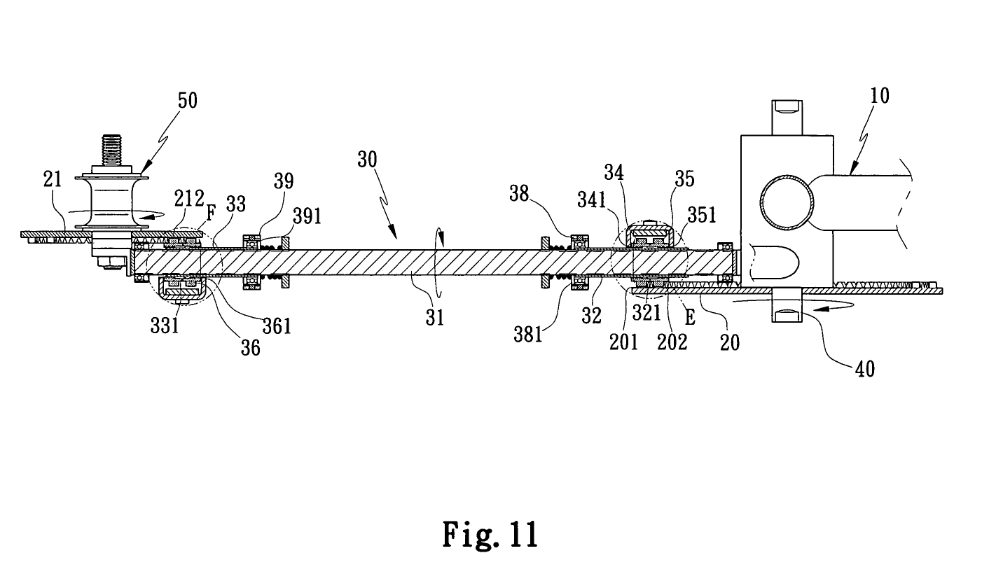

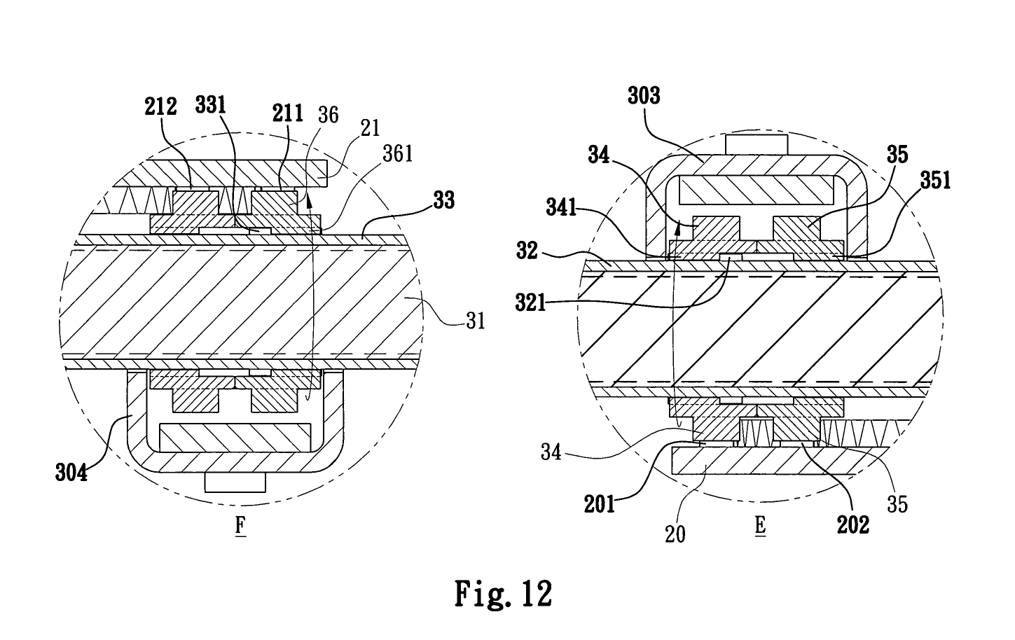

Referring to FIGS. 2 to 12, a drive system of a chainless bicycle in accordance with a first preferred embodiment of the invention is shown. The bicycle comprises a typical frame 10. The drive system comprises the following components as discussed in detail below.

A forward drive gear 20 comprises a plurality of outer projections 201 arranged as a circle formed on an inner surface and a plurality of inner projections 202 arranged as a circle formed on the inner surface. Both the outer and inner projections 201, 202 are concentric and proximate an annular edge of the drive gear 20. The drive gear 20 further comprises a centrally located cutout (not numbered) fitted onto one end of a shaft 40 and threadedly secured to the shaft 40 housed in a bottom bracket (not numbered).

A rear driven gear 21 is coaxially mounted with a rear hub 50 having a rear axle (not numbered) which is coaxially mounted with a rear wheel (not shown) and corotates therewith. The driven gear 21 comprises a plurality of outer projections 211 arranged as a circle formed on an inner surface and a plurality of inner projections 212 arranged as a circle formed on the inner surface. Both the outer and inner projections toothed sections 211, 212 are concentric and proximate an annular edge of the driven gear 21.

A drive shaft unit 30 is rotatably interconnected the drive gear 20 and the driven gear 21 as detailed below. The drive shaft unit 30 comprises a drive shaft 31 including an intermediate portion (not numbered), a first toothed member 311 at one end, an annular first flange 384 formed at a joining point of the intermediate portion and the first toothed member 311, a second toothed member 312 at the other end, and an annular second flange 394 formed at a joining point of the intermediate portion and the second toothed member 312.

One end of the drive shaft 31 is rotatably supported by a first bearing seat 301 mounted on the bottom bracket of the frame 10 and the other end thereof is rotatably supported by a second bearing seat 302 mounted on a rear component (not numbered) of the frame 10 with the rear axle rotatably secured to.

A cylindrical component (not numbered) of the frame 10 is interconnected the bottom bracket of the frame 10 and the rear component of the frame 10 and is parallel with the drive shaft 31.

A front pivotal member 38 has its central portion pivotably secured to the cylindrical component of the frame 10 and comprises, in addition to the first flange 384, a lower bearing 381, a forward cable 382 having one end secured to a top and the other end secured to a front shift lever (not shown) mounted on handlebars (not shown), and a forward coil spring 383 compressed between the first flange 384 and the lower bearing 381.

A rear pivotal member 39 has its central portion pivotably secured to the cylindrical component of the frame 10 and comprises, in addition to the second flange 394, a lower bearing 391, a rear cable 392 having one end secured to a top and the other end secured to a rear shift lever (not shown) mounted on handlebars (not shown), and a rear coil spring 393 compressed between the second flange 394 and the lower bearing 391.

A forward housing member 303 between the front pivotal member 38 and the first bearing seat 301 is mounted on the cylindrical component of the frame 10. A rear housing member 304 between the rear pivotal member 39 and the second bearing seat 302 is mounted on the cylindrical component of the frame 10.

A first gearwheel 34 having a toothed portion 341 on an inner surface and a second gearwheel 35 having a toothed portion 351 on an inner surface are partially housed in the forward housing member 303 in a parallel configuration. A forward sleeve 32 has a first toothed portion 321 on an intermediate portion of an outer surface and a second toothed portion 322 on an inner surface. The second toothed portion 322 is meshed with the first toothed member 311 when the forward sleeve 32 is put on the first toothed member 311. The first and second gearwheels 34, 35 are put on the forward sleeve 32 with the toothed portion 351 being meshed with the first toothed portion 321. A rear end of the forward sleeve 32 is fixedly disposed in the lower bearing 381 of the front pivotal member 38 and a forward end thereof is spaced from the first bearing seat 301.

A third gearwheel 36 having a toothed portion 361 on an inner surface and a fourth gearwheel 37 having a toothed portion 371 on an inner surface are partially housed in the rear housing member 304 in a parallel configuration. A rear sleeve 33 has a first toothed portion 331 on an intermediate portion of an outer surface and a second toothed portion 332 on an inner surface. The second toothed portion 332 is meshed with the second toothed member 312 when the rear sleeve 33 is put on the second toothed member 312. The third and fourth gearwheels 36, 37 are put on the rear sleeve 33 with the toothed portion 371 being meshed with the first toothed portion 331. A forward end of the rear sleeve 33 is fixedly disposed in the lower bearing 391 of the rear pivotal member 39 and a rear end thereof is spaced from the second bearing seat 302.

The outer projections 201 and the inner projections 202 are meshed with the first gearwheel 34 and the second gearwheel 35 respectively. The outer projections 211 and the inner projections 212 are meshed with the third gearwheel 36 and the fourth gearwheel 37 respectively.

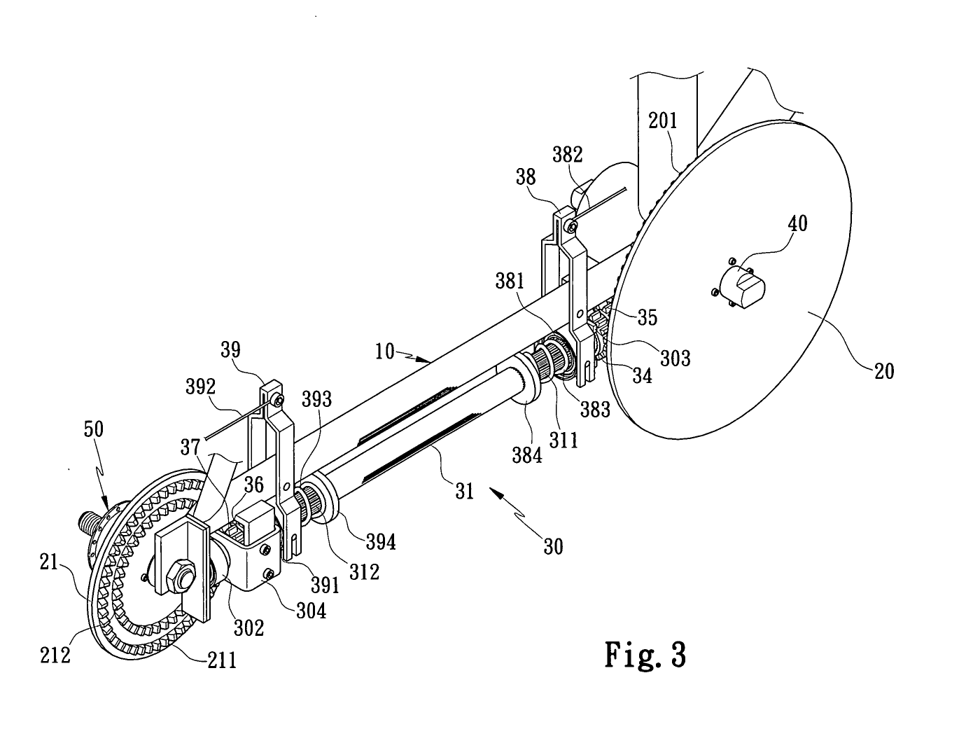

A pedaling operation of the bicycle will be described in detail below by referring to FIGS. 3 to 6 specifically. First, a rotation of the shaft 40 by pedaling of the bicycle will rotate the drive gear 20. Hence, the first and second gearwheels 34, 35 rotate in which a rotation of the first gearwheel 34 will not rotate the forward sleeve 32 and a rotation of the second gearwheel 35 will rotate the forward sleeve 32 due to the meshing engagement of the toothed portion 351 of the second gearwheel 35 and the first toothed portion 321. And in turn, the drive shaft 31 rotates due to the meshing engagement of the second toothed portion 322 and the first toothed member 311. And in turn, the rear sleeve 33 rotates due to the meshing engagement of the second toothed portion 332 and the second toothed member 312. And in turn, the fourth gearwheel 37 rotates due to the meshing engagement of the toothed portion 371 of the fourth gearwheel 37 and the first toothed portion 331. Thus both the outer projections 211 and the inner projections 212 rotate. But a rotation of the third gearwheel 36 is independent from that of the rear sleeve 33. Finally, the rear axle rotates (i.e., the bicycle moves forward).

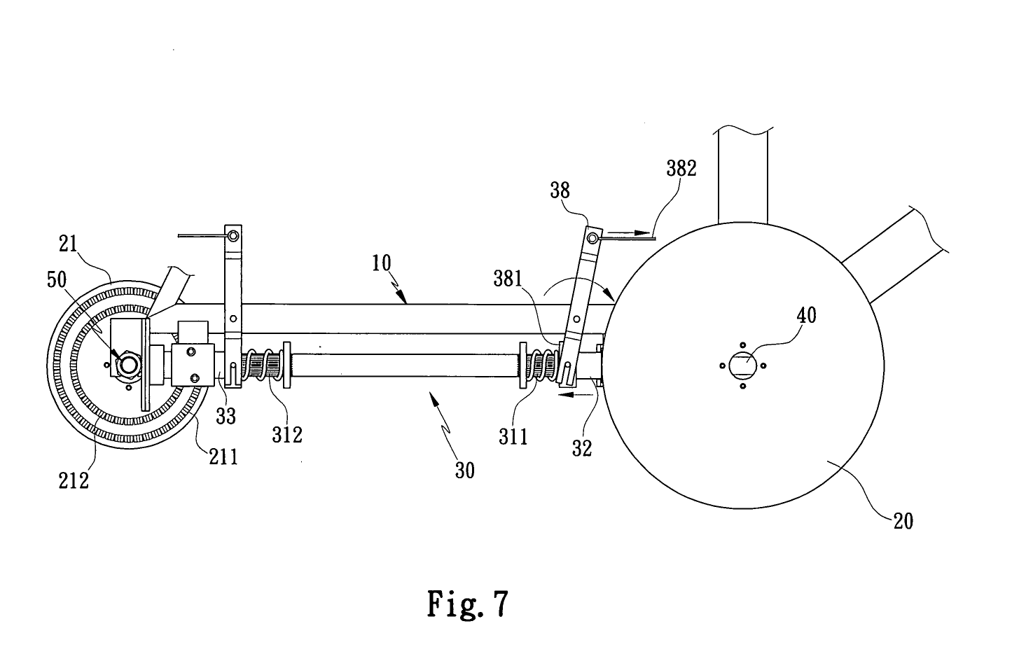

A speed change operation of the bicycle will be described in detail below by referring to FIGS. 7 to 9 specifically. First, pulling the cable 382 forward will clockwise pivot the front pivotal member 38. And in turn, the forward sleeve 32 moves rearward with the forward coil spring compressed. The first toothed portion 321 then moves into the first gearwheel 34 to mesh with the toothed portion 341. That is, the first toothed portion 321 and the second gearwheel 35 are disengaged. Next, a rotation of the shaft 40 by pedaling of the bicycle will rotate the drive gear 20. Hence, the first and second gearwheels 34, 35 rotate in which a rotation of the second gearwheel 35 will not rotate the forward sleeve 32 and a rotation of the first gearwheel 34 will rotate the forward sleeve 32 due to the meshing engagement of the toothed portion 341 of the first gearwheel 34 and the first toothed portion 321. And in turn, the drive shaft 31 rotates due to the meshing engagement of the second toothed portion 322 and the first toothed member 311. And in turn, the rear sleeve 33 rotates due to the meshing engagement of the second toothed portion 332 and the second toothed member 312. And in turn, the fourth gearwheel 37 rotates due to the meshing engagement of the toothed portion 371 of the fourth gearwheel 37 and the first toothed portion 331. Thus both the outer projections 211 and the inner projections 212 rotate. But a rotation of the third gearwheel 36 is independent from that of the rear sleeve 33. Finally, the rear axle rotates (i.e., the bicycle moves forward). But the moving speed of the bicycle is increased because the rotation of the rear axle is activated by the rotation of the inner projections 202 similar to derailing chains onto different sprockets in a chain-driven bicycle with speed change capability.

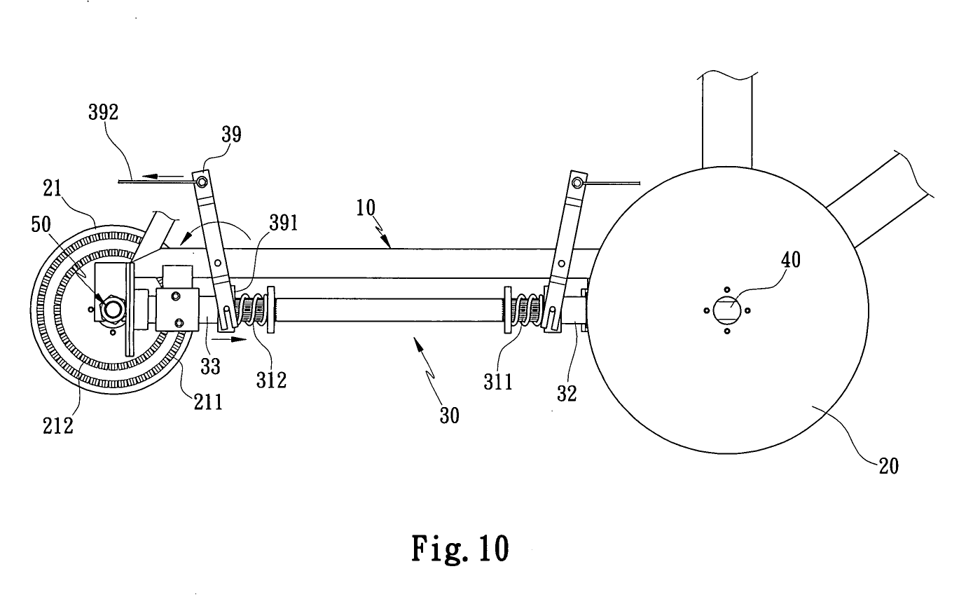

An alternative speed change operation of the bicycle will be described in detail below by referring to FIGS. 10 to 12 specifically. First, pulling the cable 392 rearward will counterclockwise pivot the rear pivotal member 39. And in turn, the rear sleeve 33 moves forward with the rear coil spring compressed. The first toothed portion 331 then moves into the third gearwheel 36 to mesh with the toothed portion 361. That is, the first toothed portion 331 and the fourth gearwheel 37 are disengaged. Next, a rotation of the shaft 40 by pedaling of the bicycle will rotate the drive gear 20. Hence, the third gearwheel 36 rotates due to the meshing engagement of the toothed portion 361 of the third gearwheel 36 and the first toothed portion 331. Thus both the outer projections 211 and the inner projections 212 rotate. But a rotation of the fourth gearwheel 37 is independent from that of the rear sleeve 33. Finally, the rear axle rotates (i.e., the bicycle moves forward). But the moving speed of the bicycle is increased because the rotation of the rear axle is activated by the rotation of the inner projections 212 similar to derailing chains onto different sprockets in a chain-driven bicycle with speed change capability.

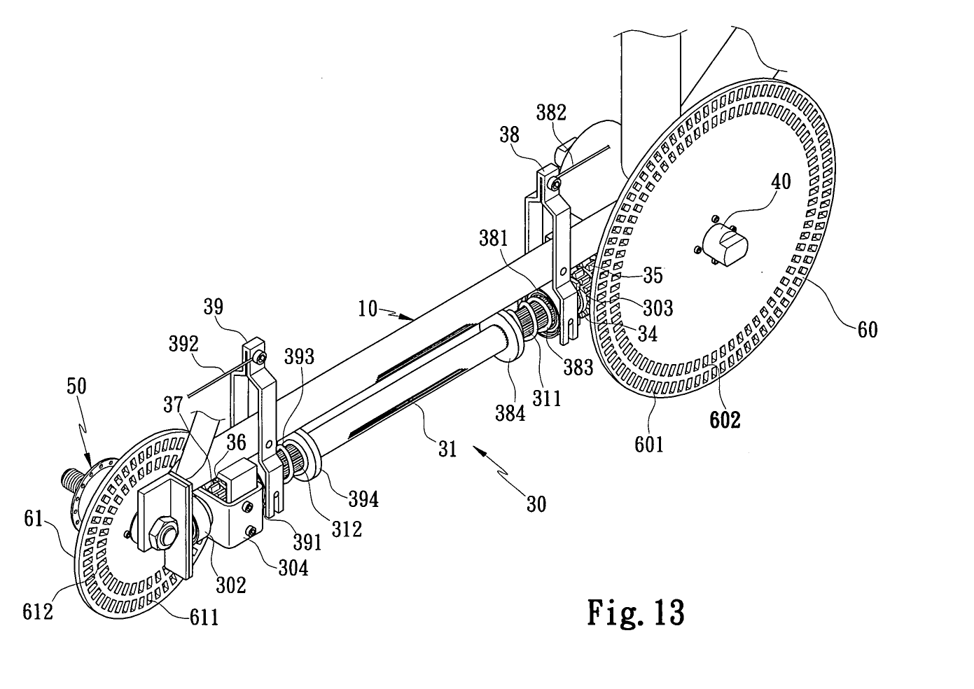

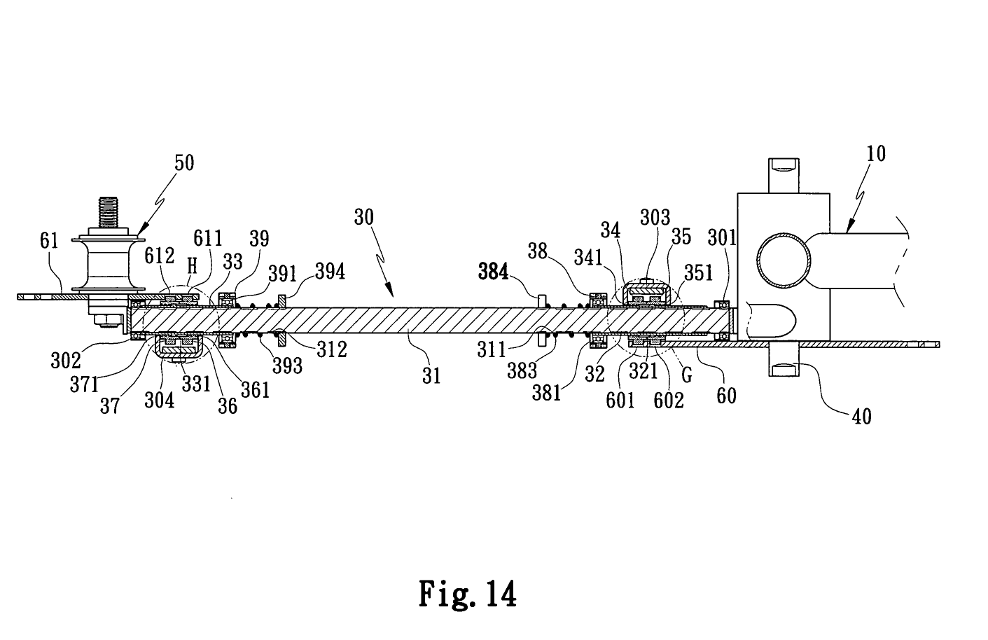

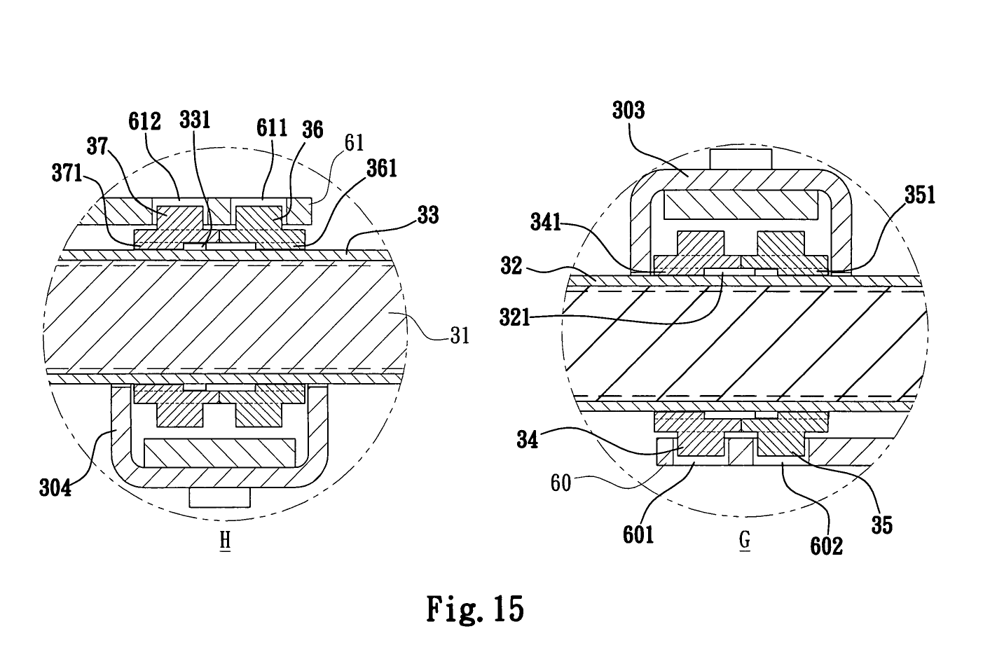

Referring to FIGS. 13 to 15, a drive system of a chainless bicycle in accordance with a second preferred embodiment of the invention is shown. The second embodiment is identical to the first embodiment, except that a forward drive gear 60 comprises a plurality of outer through holes 601 arranged as a circle and a plurality of inner through holes 602 arranged as a circle. Both the outer and inner through holes 601, 602 are concentric and proximate an annular edge of the drive gear 60 A rear driven gear 61 comprises a plurality of outer through holes 611 arranged as a circle and a plurality of inner through holes 612 arranged as a circle. Both the outer and inner through holes 611, 612 are concentric and proximate an annular edge of the driven gear 61. The outer through holes 601 and the inner through holes 602 are meshed with the first gearwheel 34 and the second gearwheel 35 respectively. The outer through holes 611 and the inner through holes 612 are meshed with the third gearwheel 36 and the fourth gearwheel 37 respectively.

The pedaling and speed change operations of the second preferred embodiment of the invention are the same as that described in the first preferred embodiment of the invention. Thus, a detailed description thereof is therefore deemed unnecessary.

While the invention herein disclosed has been described by means of specific embodiments, numerous modifications and variations could be made thereto by those skilled in the art without departing from the scope and spirit of the invention set forth in the claims.

What is claimed is:

1. A drive and speed change system for a chainless bicycle comprising:
a frame;
a shaft mounted on the frame;
a rear hub mounted on the frame;
a drive gear mounted with the shaft and comprising a plurality of engaging members;
a driven gear mounted with the rear hub and comprising an engaging element; and
a drive shaft unit interconnecting the drive gear and the driven gear and comprising:
a drive shaft rotatably interconnecting the drive gear and the driven gear;
front and rear sleeves mounted on both ends of the drive shaft respectively and each comprising a first toothed portion on an outer surface and a second toothed portion on an inner surface meshed with either end of the drive shaft to be adapted to move relative to either end of the drive shaft;
a plurality of drive gearwheels put on the front sleeve and meshed with the engaging members of the drive gear, each of the drive gearwheels comprising a toothed portion on an inner surface adapted to mesh with the first toothed portion of the front sleeve; and
a driven gearwheel put on the rear sleeve and meshed with the engaging elements of the driven gear, each of the driven gearwheels comprising a toothed portion on an inner surface adapted to mesh with the first toothed portion of the rear sleeve.

2. The drive and speed change system for a chainless bicycle of claim 1, further comprising first and second bearing seats formed on the frame for rotatably supporting both ends of the drive shaft which interconnects the drive gear and the driven gear.

3. The drive and speed change system for a chainless bicycle of claim 1, wherein the engaging members of the drive gear are formed on an inner surface of the drive gear and comprise a plurality of outer engaging members and a plurality of inner engaging members.

4. The drive and speed change system for a chainless bicycle of claim 3, wherein each of the outer and inner engaging members is a projection.

5. The drive and speed change system for a chainless bicycle of claim 3, wherein each of the outer and inner engaging members is a through hole.

6. The drive and speed change system for a chainless bicycle of claim 3, wherein the drive gearwheels comprise a first drive gearwheel meshed with the outer engaging member of the drive gear, and a second drive gearwheel meshed with the inner engaging member of the drive gear, the frame comprises a forward housing member for housing the first and second drive gearwheels, the first toothed portion of the front sleeve is annular, the first drive gearwheel has an annular toothed portion on an inner surface, the second drive gearwheel has an annular toothed portion on an inner surface, and the first toothed portion of the front sleeve is adapted to move either into the first drive gearwheel to mesh with the toothed portion of the first drive gearwheel or into the second drive gearwheel to mesh with the toothed portion of the second drive gearwheel.

7. The drive and speed change system for a chainless bicycle of claim 1, wherein the engaging elements of the driven gear are annular projections.

8. The drive and speed change system for a chainless bicycle of claim 1, wherein the engaging elements of the driven gear are annular through holes.

9. The drive and speed change system for a chainless bicycle of claim 1, wherein both ends of the drive shaft are formed with first and second toothed members with the second toothed portions of the front and rear sleeves meshed therewith so that the front sleeve is adapted to move relative to the first toothed member of the drive shaft and the rear sleeve is adapted to move relative to the second toothed member of the drive shaft respectively.

10. The drive and speed change system for a chainless bicycle of claim 1, further comprising a front pivotal member pivotably secured to the frame and comprising a lower bearing, a forward cable extending from an upper portion of the front pivotal member, a first stop member formed on the drive shaft, and first spring means compressed between the first stop member and the lower bearing of the front pivotal member; and a rear pivotal member pivotably secured to the frame and comprising a lower bearing, a rear cable extending from an upper portion of the rear pivotal member, a second stop member formed on the drive shaft, and second spring means compressed between the second stop member and the lower bearing of the rear pivotal member.

11. A drive and speed change system for a chainless bicycle comprising:
a frame;
a shaft mounted on the frame;
a rear hub mounted on the frame;
a drive gear mounted with the shaft and comprising an engaging member;
a driven gear mounted with the rear hub and comprising a plurality of engaging elements; and
a drive shaft unit interconnecting the drive gear and the driven gear and comprising:
a drive shaft rotatably interconnecting the drive gear and the driven gear;
front and rear sleeves mounted on both ends of the drive shaft respectively and each comprising a first toothed portion on an outer surface and a second toothed portion on an inner surface meshed with either end of the drive shaft to be adapted to move relative to either end of the drive shaft;
a drive gearwheel put on the front sleeve and meshed with the engaging members of the drive gear, the drive gearwheel comprising a toothed portion on an inner surface adapted to mesh with the first toothed portion of the front sleeve; and
a plurality of driven gearwheels put on the rear sleeve and meshed with the engaging elements of the driven gear, each of the driven gearwheels comprising a toothed portion on an inner surface adapted to mesh with the first toothed portion of the rear sleeve.

12. The drive and speed change system for a chainless bicycle of claim 11, further comprising first and second bearing seats formed on the frame for rotatably supporting both ends of the drive shaft which interconnects the drive gear and the driven gear.

13. The drive and speed change system for a chainless bicycle of claim 11, wherein the engaging member of the drive gear is comprised of a plurality of annular projections.

14. The drive and speed change system for a chainless bicycle of claim 11, wherein the engaging member of the drive gear is comprised of a plurality of annular through holes.

15. The drive and speed change system for a chainless bicycle of claim 11, wherein the engaging elements of the driven gear are formed on an inner surface of the driven gear and comprise a plurality of outer engaging elements and a plurality of inner engaging elements.

16. The drive and speed change system for a chainless bicycle of claim 15, wherein the outer and inner engaging elements are annular projections.

17. The drive and speed change system for a chainless bicycle of claim 15, wherein the outer and inner engaging elements are annular through holes.

18. The drive and speed change system for a chainless bicycle of claim 11, wherein the drive gearwheels comprise a first drive gearwheel meshed with the outer engaging member of the drive gear, and a second drive gearwheel meshed with the inner engaging member of the drive gear, the frame comprises a forward housing member for housing the first and second drive gearwheels, the first toothed portion of the front sleeve is annular, the first drive gearwheel has an annular toothed portion on an inner surface, the second drive gearwheel has an annular toothed portion on an inner surface, and the first toothed portion of the front sleeve is adapted to move either into the first drive gearwheel to mesh with the toothed portion of the first drive gearwheel or into the second drive gearwheel to mesh with the toothed portion of the second drive gearwheel.

19. The drive and speed change system for a chainless bicycle of claim 11, wherein both ends of the drive shaft are formed with first and second toothed members with the second toothed portions of the front and rear sleeves meshed therewith so that the front sleeve is adapted to move relative to the first toothed member of the drive shaft and the rear sleeve is adapted to move relative to the second toothed member of the drive shaft respectively.

20. The drive and speed change system for a chainless bicycle of claim 11, further comprising a front pivotal member pivotably secured to the frame and comprising a lower bearing, a forward cable extending from an upper portion of the front pivotal member, a first stop member formed on the drive shaft, and first spring means compressed between the first stop member and the lower bearing of the front pivotal member; and a rear pivotal member pivotably secured to the frame and comprising a lower bearing, a rear cable extending from an upper portion of the rear pivotal member, a second stop member formed on the drive shaft, and second spring means compressed between the second stop member and the lower bearing of the rear pivotal member.
